(19) United States
(12) Patent Application Publication
(10) Pub. No.: US 2003/0086023 A1
(43) Pub. Date: May 8, 2003

(54) Personal video recorder including a network interface

(75) Inventors: Hye-Chun Chung, Nam-Ku (KR); Won-Wook Yoo, Buk-Ku (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/287,631

(22) Filed: Nov. 5, 2002

(30) Foreign Application Priority Data
Nov. 6, 2001 (KR) 2001-68953

(51) Int. Cl. H04N 7/173; H04N 7/16; H04N 9/64

(52) U.S. Cl. 348/714; 725/134; 725/142

(57) ABSTRACT

Embodiments of the present invention relate to an apparatus (i.e. a Personal Video Recorder) comprising a memory (i.e. firmware), a storage device (i.e. a hard drive), and a network interface (i.e. a Local Area Network interface). The memory is configured to substantially exclusively store the operating system of the apparatus. The storage device is configured to substantially exclusively store video content (i.e. television programs). The network interface is coupled to the memory and the storage device.

### BACKGROUND OF THE INVENTION

1. Field of the Invention

The present invention relates to personal video recorders (PVR).

2. Background of the Related Art

Televisions are consumer electronic devices that have impacted the lives of many people. Particularly, televisions have enabled many people to receive audio and visual programming (i.e. television programs) that satisfy many interests (i.e. entertainment, education, information, etc.). Television programs are broadcasted over many types of mediums (i.e. radio waves, cable, and satellite signals) at specific times. However, television viewers have found that they can not always watch some desirable televisions programs because their schedule conflicts with the television-programming schedule. Accordingly, there has been a long felt need to record television programs for viewing at a later time.

Devices do exist that can record television programs. An example of such a device is a video cassette recorder (i.e. VHS). However, these recording devices do have several disadvantages. For instance, a video cassette recorder is generally limited to a recording time of between 1.5 and 6 hours for each video cassette. This limited recording time may be inadequate for recording a series of programs at scheduled times. Additionally, recording on some video cassettes is analog and the reproduction quality may consequently be low.

### SUMMARY OF THE INVENTION

Objects of the present invention at least include overcoming the disadvantages of the related art. Embodiments of the present invention relate to an apparatus (i.e. a Personal Video Recorder) comprising a memory (i.e. firmware), a storage device (i.e. a hard drive), and a network interface (i.e. a Local Area Network interface). The memory is configured to substantially exclusively store the operating system of the apparatus. The storage device is configured to substantially exclusively store video content (i.e. television programs). The network interface is coupled to the memory and the storage device.

Embodiments of the present invention are advantageous, as a large amount of video content can be stored on a storage device for future viewing at the convenience of the viewer. However, because the storage device has a finite capacity, embodiments of the present invention utilize a network interface to download (i.e. on-demand or in real-time) video content from another location. This downloading is advantageous, as a viewer is not limited to viewing video content that is stored on the storage device or video content that is being broadcasted in real-time over a television network.

Advantages of embodiments may be particularly useful, in embodiments wherein the apparatus is a Personal Video Recorder. Personal Video Recorders are consumer electronic devices which comprise or are coupled to at least one television tuner. A PVR may be configured to store video content in a storage device that is received from the at least one television tuner. If a user desires to view video content at a future time, recording of the video content by a PVR may be either specified by a user in real-time (i.e. during broadcasting of the television program) or in advance (i.e. prior to the broadcast of a television program). However, because the storage device has a finite capacity, it may not be possible for the PVR to record all of the video content specified by the user. Alternatively, the user may have an initial desire to view previously broadcasted video content, after it has been broadcasted. According to embodiments of the present invention, a PVR can utilize a network interface to download content from another apparatus (i.e. another PVR). Accordingly, in these embodiments, a user can view the desired video content at a later time (i.e. after the capacity of the storage device is no longer saturated or in real-time).

Additional advantages, objects, and features of the invention will be set forth in part in the description which follows and in part will become apparent to those having ordinary skill in the art upon examination of the following or nay be learned from practice of the invention. The objects and advantages of the invention may be realized and attained as particularly pointed out in the appended claims.

### BRIEF DESCRIPTION OF THE DRAWINGS

FIG. 1 is an exemplary block diagram illustrating a recording and reproducing device.

FIG. 2 is an exemplary block diagram illustrating an overall Personal Video Recorder (PVR) system, in which one or more recording and reproducing devices share storage devices.

FIG. 3 is an exemplary flowchart illustrating procedures of establishing a database at a server in a networked PVR system.

FIG. 4 is an exemplary flowchart illustrating procedures of a recording and reproducing device operating as a master in a networked PVR system.

FIG. 5 is an exemplary flowchart illustrating procedures of a recording and reproducing device operating as a slave in a networked PVR system.

### DETAILED DESCRIPTION OF PREFERRED EMBODIMENTS

Embodiments of the present invention relate to Personal Video Recorders (PVR) that may simultaneously record programs broadcast by different broadcasting stations. PVRs may employ a hard disk to store up to 30 hours of programming. Exemplary PVRs include a central processing unit (CPU) and/or a video signal processor. The CPU and/or video signal processor may convert received television broadcasts (i.e. digital broadcasting data items of an ATSC specification or analog broadcasting data items of a NTSC specification) into a digital signal. The digital signal may be then stored on a memory apparatus (i.e. a hard disk). The broadcasting data items stored in the hard disk may be reproduced at a later on a display apparatus (i.e. a television screen). The key functions of a PVR is program recording and replaying of a recorded program.

In embodiments of the present invention, a viewer can simultaneously record one or more other broadcasted television programs. At a later time, the viewer can selectively watch one of the recorded programs. However, the capacity of a hard disk installed in a PVR system is finite. This restricts the quantity of television programming that can be stored on the hard disk. One solution to this problem is for a user to delete a stored program from the hard drive to free up space. This deletion can be accomplished either manually or automatically. However, this solution has the disadvantage of the possibility that a deleted program has not yet been viewed by the user or that the user desires to view this program again in future.

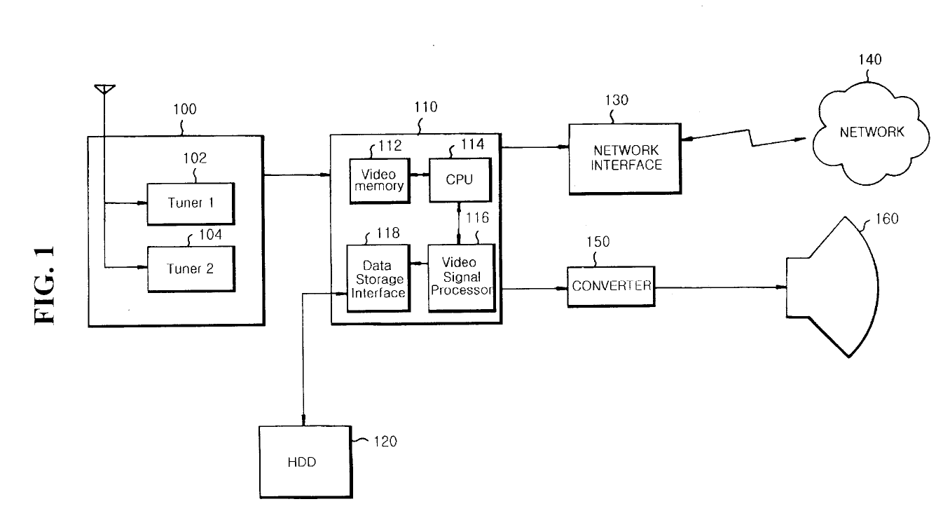

FIG. 1 is an exemplary block diagram illustrating a recording and reproducing device according to embodiments of the present invention. A recording and reproducing device may include a tuner 100, a digital signal processor 110, a hard disk 120, a network interface 130, a digital-to-analog (D/A) converter 150, and/or a display 160. The hard disk 120 is a storage device. The network interface 130 may be for letting a recording and reproducing device connect to an external network. The digital-to-analog (D/A) converter 150 may be for converting a digital broadcasting signal into an analog signal.

Tuner 100 may receive broadcasting data transmitted from a broadcasting network, convert the broadcasting data into a baseband signal that can be processed, and/or transmit the baseband signal to digital signal processor 110. Digital broadcasting data may be received at tuner1 102, which may be an ATSC tuner. Broadcasting data of an NTSC specification may be received at tuner2 104.

Digital signal processor 110 may include a video memory 112, a central processing unit (CPU) 114, a video signal processor 116, and/or a data storage interface 118. Digital signal processor 110 may receives a tuned broadcasting signal from a tuner, convert the broadcasting signal into a digital signal through the CPU 114 and/or the video signal processor 116, and/or compress an image. Converted broadcasting signals may be stored on hard disk 120 through data storage interface 118. Broadcasting programs received from a tuner or stored on hard disk 120 may be converted into analog signals through a digital-to-analog (D/A) converter and reproduced on a display 160. Accordingly, users can watch broadcasting programs.

In embodiments, a recording and reproducing device may include network interface 130 that may be connected to an external network. The network may include at least one of the Internet and an intranet. A modem, a leased line, and/or a LAN may be used to connect to network interface 130. In embodiments, data exchanges of broadcasting programs are performed through communication with other recording and reproducing devices connected to the network (i.e. the Internet).

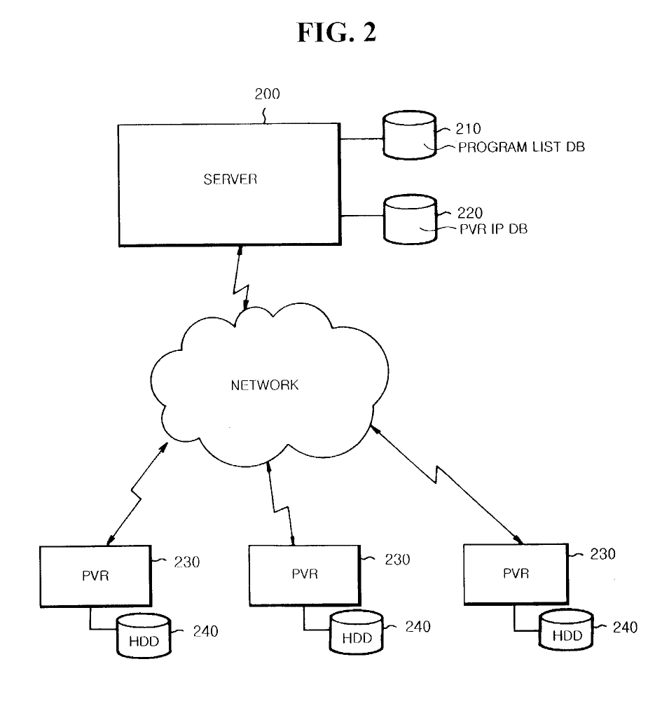

FIG. 2 is an exemplary block diagram illustrating an overall system, wherein a plurality of PVRs are connected to each other through a network. A PVR system may include a server 200 and/or PVRs 230. The server may include databases 210 and 220. PVRs 230 may include storage devices 240. PVRs may be connected to the server through the network.

Server 200 may include a PVR IP list database 220 and/or program list database 210. PVR IP database 220 may store IP addresses of respective PVRs. Program list database 210 may store a list of broadcasting programs stored in storage devices of the respective PVRs. Each PVR 230 may include a hard disk 240, which is an internal storage device. Users may store desired broadcasting programs on the hard disk. PVRs 230 may include network interfaces. Using the network interfaces, it may be possible to search or exchange data by accessing the server and/or other PVRs through an external network.

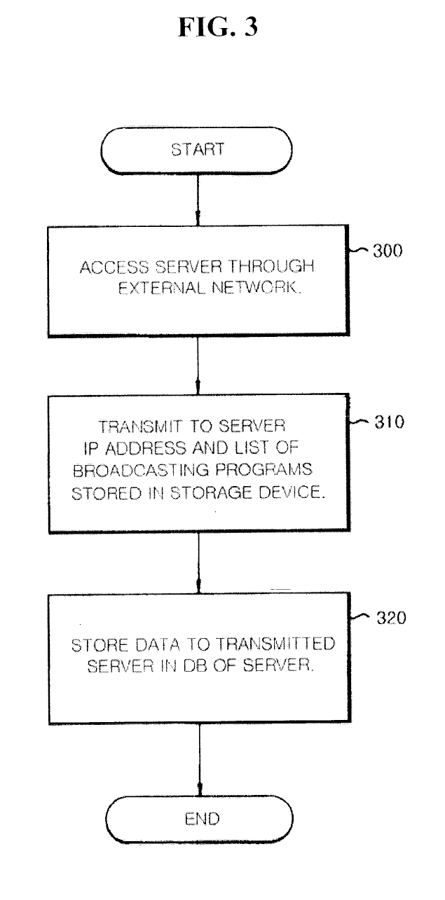

FIG. 3 is an exemplary flowchart illustrating procedures of establishing the databases of a server according to embodiments of the present invention. Respective PVRs may access a server through a network (step 300) and may then transfer their IP addresses and/or lists of broadcasting programs stored on their hard disks to the server (step 310). A server that receives IP addresses and lists of the broadcasting programs may store corresponding data items in a PVR IP list database and a program list database respectively (step 320).

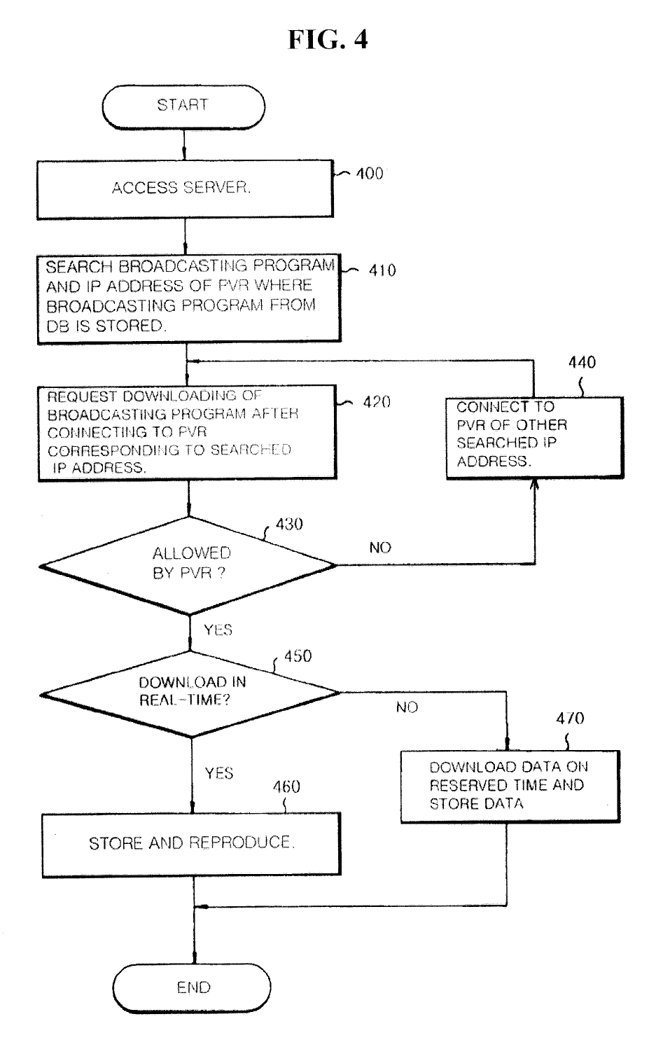

FIG. 4 is an exemplary flowchart illustrating procedures of a PVR receiving a specific broadcasting program stored in the hard disk of another PVR, in accordance with embodiments of the present invention. A user may access a server using a network interface of a PVR (step 400). A user may then search for a PVR, in which a broadcasting program to be watched is stored and extract an IP address of a PVR from a database of a server (step 410).

A user may access a PVR among PVRs corresponding to the searched IP addresses and request the PVR to download a broadcasting program (step 420). When a broadcasting program is not allowed (or unable) to be downloaded from the PVR, which requests the download of the broadcasting program, the user may access a PVR corresponding to another searched IP address and re-request download of the broadchasting program from another. When a broadcasting program is allowed (or able) to be downloaded to the PVR it may be determined whether the broadcasting program is to be received and replayed in real-time or is to be downloaded at a scheduled time in the future (step 450). If a broadcasting program is received in real-time, the transferred broadcasting program may be stored on a hard disk of a PVR and reproduced on a display at substantially the same time. When the broadcasting program is downloaded at a scheduled time, data is received from a remote PVR at a predetermined time and is stored on a hard disk of a user's PVR (step 470).

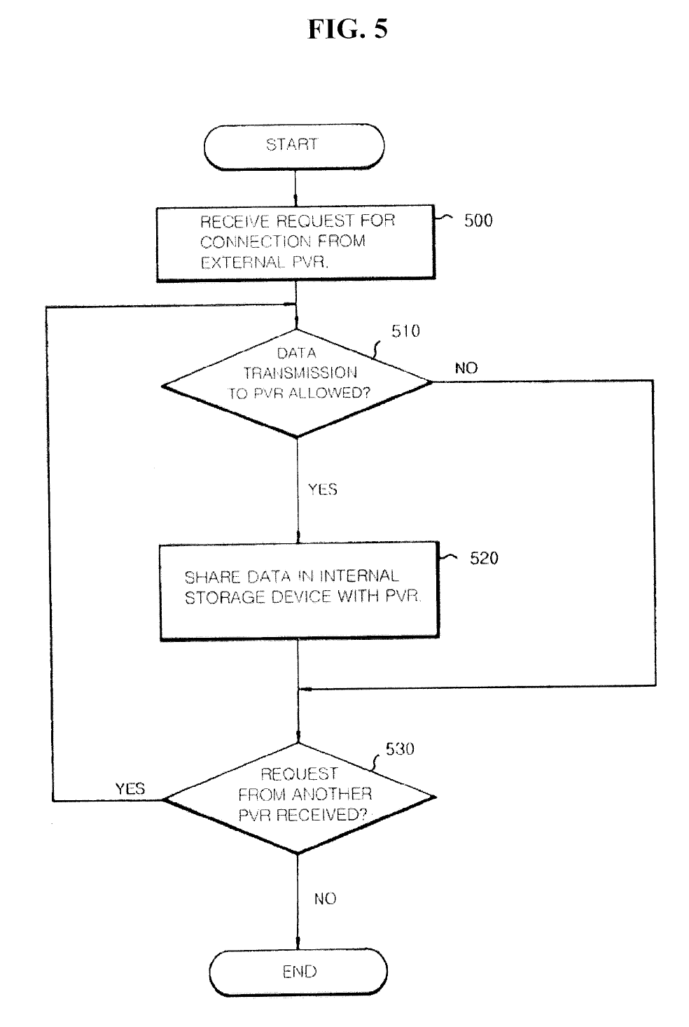

FIG. 5 is an exemplary flowchart illustrating procedures of downloading a broadcasting program from a VDR over a network. A PVR may request to download broadcasting from another PVR over a network (step 500). It may be determined whether a broadcasting program can or may be downloaded (step 510). If a broadcasting program cannot be downloaded, a message announcing that a broadcasting program cannot be downloaded is transferred to the requesting PVR. A PVR may then periodically check whether another PVR can be accessed to download the broadcasting program. During downloading of a broadcasting program, the broadcasting program stored in a hard disk is shared with a requesting PVR (step 520).

Embodiments of the present invention are directed to a personal video recorder (PVR) capable of sharing storage devices based on a network. Objects of embodiments of the present invention are to provide a recording and reproducing device capable of recovering restriction of capacity of a hard disk, wherein the hard disk is a storage device installed in the recording and reproducing device. Objects of embodiments of the present invention is to provide a method of sharing broadcasting programs, by which one or more recording and reproducing devices can let a viewer watch various broadcasting programs without being restricted by capacity of a built-in hard disk.

To achieve at least some of these objects and other advantages and in accordance with the purpose of the invention, as embodied and broadly described herein, embodiments of the present invention provide: A broadcasting data recording and reproducing apparatus having a built-in storage device, including a tuner for tuning a broadcasting signal received through a sky wave and converting the broadcasting signal into a signal being able to be processed. A digital signal processing section for converting the broadcasting signal transmitted from the tuner into a digital signal and compressing an image. A network interface section for allowing the broadcasting data recording and reproducing apparatus be connected with an external network, the digital signal processing section receiving the broadcasting data stored in the storage device of other broadcasting data recording and reproducing apparatus through the network interface section and outputting the broadcasting signal on a screen. In embodiments, the network interface section includes one of a MODEM, a leased line, and a LAN.

To achieve objects of the present invention, embodiments of the present invention provide a PVR system including at least a recording and reproducing device which can be connected to each ether through a network and installed with a storage device. The PVR system includes a server in which the recording and reproducing device can be connected through the network, and a database, being managed by the server, storing an IP list of each recording and reproducing device and a list with respect to broadcasting programs in the storage device in each recording and reproducing device, the recording and reproducing device connected to the server for searching a desired broadcasting program from the database, and receiving the searched program by being connected to the recording and reproducing device in which the searched program is stored.

In embodiments, the recording and reproducing device, after being connected to the server through the network, transmits an IP address of the recording and reproducing device and the list with respect to the broadcasting programs in the storage device in the recording and reproducing device, and the server stores and manages the transmitted broadcasting data in the database.

In embodiments, the recording and reproducing device searches the IP address of the recording and reproducing device in which a specific broadcasting program is stored from the database of the server, and download the specific broadcasting program by requesting a transmission of the specific broadcasting program by being connected to the recording and reproducing device having the IP address through the network.

In embodiments, one or more recording and reproducing devices, in which storage devices are installed, can share the storage devices using a network. As a result, a user can watch all of the broadcasting programs without being restricted by the capacity of a storage device built-in a PVR, which ishis or her own recording and reproducing device.

According to embodiments of the present invention, it is possible to share broadcasting programs stored in the hard disk included in each PVR and to search for the list of the broadcasting programs stored in each PVR through at least one database stored in the server. Therefore, it is possible to mitigate the restrictions of the capacity of the hard disk and to effectively use the hard disk.

The foregoing embodiments and advantages are merely exemplary and are not to be construed as limiting the present invention. The present teaching can be readily applied to other types of apparatuses. The description of the present invention is intended to be illustrative, and not to limit the scope of the claims.

What is claimed is:

1. A first apparatus comprising:
a first memory configured to substantially exclusively store an operating system of the first apparatus;
a first storage device configured to substantially exclusively store video content; and
a first network interface coupled to the first memory and the first storage device.

2. The first apparatus of claim 1, wherein the first storage device is a hard drive.

3. The apparatus of claim 1, wherein the first apparatus is a personal video recorder.

4. The apparatus of claim 1, wherein the first memory and the first operating system are firmware.

5. The apparatus of claim 1, wherein the first memory is a read only memory.

6. The apparatus of claim 1, wherein the video content comprises a television program.

7. The apparatus of claim 6, wherein the television program was received from a tuner.

8. The apparatus of claim 1, wherein the first network interface is configured to transmit or receive video content to or from the first storage device.

9. The apparatus of claim 8, wherein the network interface is configured to transmit or receive video content to or from a second apparatus, wherein said second apparatus comprises:
a second memory configured to substantially exclusively store an operating system;
a second storage device configured to substantially exclusively store video content; and
a second network interface coupled to the second memory and the second storage device.

10. The apparatus of claim 9, wherein the apparatus is configure to replay video content that is received in real-time.

11. The apparatus of claim 9, wherein the apparatus is configured to transmit or receive video content at a time specified by a user.

12. The apparatus of claim 1, wherein the network interface is configured to communicate with a server for locating video content on a second apparatus, wherein the second apparatus comprises:
a second memory configured to substantially exclusively store an operating system;
a second storage device configured to substantially exclusively store video content; and
a second network interface coupled to the second memory and the second storage device.

13. The apparatus of claim 12, wherein the server comprises at least one database.

14. The apparatus of claim 13, wherein the at least one database stores program lists and network addresses of said second apparatus.

15. A method comprising:
searching a server for a location of video content; and
downloading the video content from the location to a first apparatus, wherein the first apparatus comprises:
a first memory configured to substantially exclusively store an operating system of the first apparatus;
a first storage device configured to substantially exclusively store video content; and
a first network interface coupled to the first memory and the first storage device.

16. The method of claim 15, wherein the downloading comprises downloading the video content from a second apparatus at the location, wherein the second apparatus comprises:
a second memory configured to substantially exclusively store an operating system;
a second storage device configured to substantially exclusively store video content; and
a second network interface coupled to the second memory and the second storage device.

17. An apparatus comprising:
at least one electrical component; and
a means for recording, downloading, and playing video content with said at least one electrical component.

18. A broadcasting data recording and reproducing apparatus having a built-in storage device, comprising:
a tuner for tuning a broadcasting signal received through a sky wave and converting the broadcasting signal into a signal being able to be processed;
a digital signal processing section for converting the broadcasting signal transmitted from the tuner into a digital signal and compressing an image; and
a network interface section for allowing the broadcasting data recording and reproducing apparatus to be connected with an external network;
wherein the digital signal processing section receiving the broadcasting data stored in a storage device of other broadcasting data recording and reproducing apparatus through the network interface section and displaying the broadcasting signal on a screen.

19. The broadcasting data recording and reproducing apparatus as claimed in claim 18, wherein the network interface section comprises at least one of a MODEM, a leased line, and a LAN.

20. A PVR system including at least a recording and reproducing device which can be accessed to each other through a network and installed with a storage device, the PVR system comprising:
a server being to which the recording and reproducing device can be accessed through the network; and
a database, being managed by the server, storing an IP list of each recording and reproducing device and a list with respect to broadcasting programs in the storage device in each recording and reproducing device;
wherein the recording and reproducing device accessed to the server for searching a desired broadcasting program from the database, and receiving the searched program by being accessed to the recording and reproducing device in which the searched program is stored.

21. The PVR system as claim in claim 20, wherein the recording and reproducing device, after being accessed to the server through the network, transmits an IP address of the recording and reproducing device and the list with respect to the broadcasting programs in the storage device in the recording and reproducing device, and the server stores and manages the transmitted broadcasting data in the database.

22. The PVR system as claimed in claim 20, wherein the recording and reproducing device searches the IP address of the recording and reproducing device in which a specific broadcasting program is stored from the database of the server, and download the specific broadcasting program by requesting a transmission of the specific broadcasting program by being connected to the recording and reproducing device having the IP address through the network.

23. The PVR system as claimed in claim 22, wherein the recording and reproducing device, which is requested to transfer the specific broadcasting program stored in the storage device of the recording and reproducing device by an external, transfers a message indicating an allowance or disallowance for downloading, and is switched to a state that data with respect to the broadcasting program can be shared if the recording and reproducing device allows to down load.

24. A method for sharing a broadcasting program stored in respective recording and reproducing devices in a system including at least the recording and reproducing device, a server which the recording and reproducing device is connected through a network, the method comprising the steps of:
a) accessing the recording and reproducing device to the server through the network;
b) transmitting information of an IP address of the recording and reproducing device connected to the server and a list of broadcasting programs stored in a storage device of the recording and reproducing device to the server;
c) searching a specific broadcasting program by using a database stored in the server;
d) extracting the IP address of the recording and reproducing device where the specific broadcasting program is stored when the specific broadcasting program is searched; and
e) downloading the broadcasting program by being accessed to a recording and reproducing device corresponding to the extracted IP address.

25. The method as claimed in claim 24, wherein the step b) comprises the sub-steps of:
i) determining whether information of the list of the broadcasting program of the recording and reproducing device connected to the server is stored in the server by the recording and reproducing device;
ii) transmitting information of the IP address of the recording and reproducing device and the list of the broadcasting program stored in the storage device of the recording and reproducing device to the server when the information of the list of the broadcasting list is not stored; and
iii) transmitting an update information of the list of the broadcasting list stored in the storage device of the recording and reproducing device when the information of the list of the broadcasting list is stored.

26. The method as claimed in claim 24, further comprising the steps of:
f) requesting to the recording and reproducing device connected to the server to transmit the specific broadcasting program by an external;
g) determining whether sharing the requested specific broadcasting program or not; and
h) setting the specific broadcasting program as sharing state when the requested specific broadcasting program is determined to be shared.

27. A method for sharing broadcasting programs stored in respective recording and reproducing devices in a system including a database storing IP addresses of the respective recording and reproducing devices and a list of the broadcasting programs stored in the respective recording and reproducing devices, a server which the respective recording and reproducing devices are connected through a network, the method comprising the steps of:
a) transmitting the IP address and the list of the broadcasting programs from an external recording and reproducing device through the network, the broadcasting programs being stored in the external recording and reproducing device;
b) making the transmitted IP addresses and list into a database;
c) searching a specific broadcasting program by a request from the external recording and reproducing device; and
d) transmitting an IP address of the recording and reproducing device where the searched specific broadcasting program is stored to the external recording and reproducing device.
